(19) United States
(12) Patent Application Publication
(10) Pub. No.: US 2026/0006013 A1
(43) Pub. Date: Jan. 1, 2026

(54) ARTIFICIAL INTELLIGENCE-BASED AUTHENTICATION SYSTEM WITH PROCESSING OF DATA STRUCTURES

(71) Applicant: Dell Products L.P., Round Rock, TX (US)

(72) Inventors: Vivek Bhargava, Bangalore (IN); Abhishek Mishra, Bangalore (IN); Pravin Janakiram, Bangalore (IN); Vaideeswaran Ganesan, Bangalore (IN); Ajith Navada, Davangere District (IN)

(21) Appl. No.: 18/754,895

(22) Filed: Jun. 26, 2024

(51) Int. Cl. H04L 9/40

(52) U.S. Cl. CPC H04L 63/08; H04L 63/105

(57) ABSTRACT

Methods, apparatus, and processor-readable storage media for artificial intelligence-based authentication systems with processing of data structures are provided herein. An example computer-implemented method includes obtaining information pertaining to at least one authentication request between at least one user and at least one application; determining one or more commonalities pertaining to the user(s) and the application(s) by processing, using one or more artificial intelligence techniques, a first set of one or more data structures associated with user-related data and a second set of one or more data structures associated with application-related data; generating and outputting, to at least one user device associated with the user(s), one or more queries related to user activity with respect to the application(s); and performing one or more automated actions in connection with the authentication request(s) and based on one or more user responses to at least a portion of the one or more queries.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Maintaining user web interface credentials presents various security challenges for enterprises. For example, users may leave certain teams within an enterprise, resulting in those users no longer needing access to particular resources while needing access to particular other resources. However, conventional resource access management techniques often require static subscription efforts, which can be error-prone and lead to security risks related to provisioning of resource access.

### SUMMARY

Illustrative embodiments of the disclosure provide implementation of artificial intelligence-based authentication systems with processing of data structures.

An exemplary computer-implemented method includes obtaining information pertaining to at least one authentication request between at least one user and at least one application, and determining one or more commonalities pertaining to the at least one user and the at least one application by processing, using one or more artificial intelligence techniques, a first set of one or more data structures associated with user-related data and a second set of one or more data structures associated with application-related data. The method also includes generating and outputting, to at least one user device associated with the at least one user, one or more queries related to user activity with respect to the at least one application, and performing one or more automated actions in connection with the at least one authentication request and based at least in part on one or more user responses to at least a portion of the one or more queries.

Illustrative embodiments can provide significant advantages relative to conventional resource access management techniques. For example, problems associated with security risks related to provisioning of resource access are overcome in one or more embodiments through dynamically managing resource access privileges by processing user-related and application-related data structures using artificial intelligence techniques.

These and other illustrative embodiments described herein include, without limitation, methods, apparatus, systems, and computer program products comprising processor-readable storage media.

### BRIEF DESCRIPTION OF THE DRAWINGS

FIG. 1 shows an information processing system configured for dynamically managing resource access privileges using artificial intelligence techniques in an illustrative embodiment.

FIG. 2 shows example system architecture in an illustrative embodiment.

FIG. 3 shows example pseudocode for implementing at least a portion of an artificial intelligence-based authentication system in an illustrative embodiment.

FIG. 4 is a flow diagram of a process for dynamically managing resource access privileges using artificial intelligence techniques in an illustrative embodiment.

FIGS. 5 and 6 show examples of processing platforms that may be utilized to implement at least a portion of an information processing system in illustrative embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

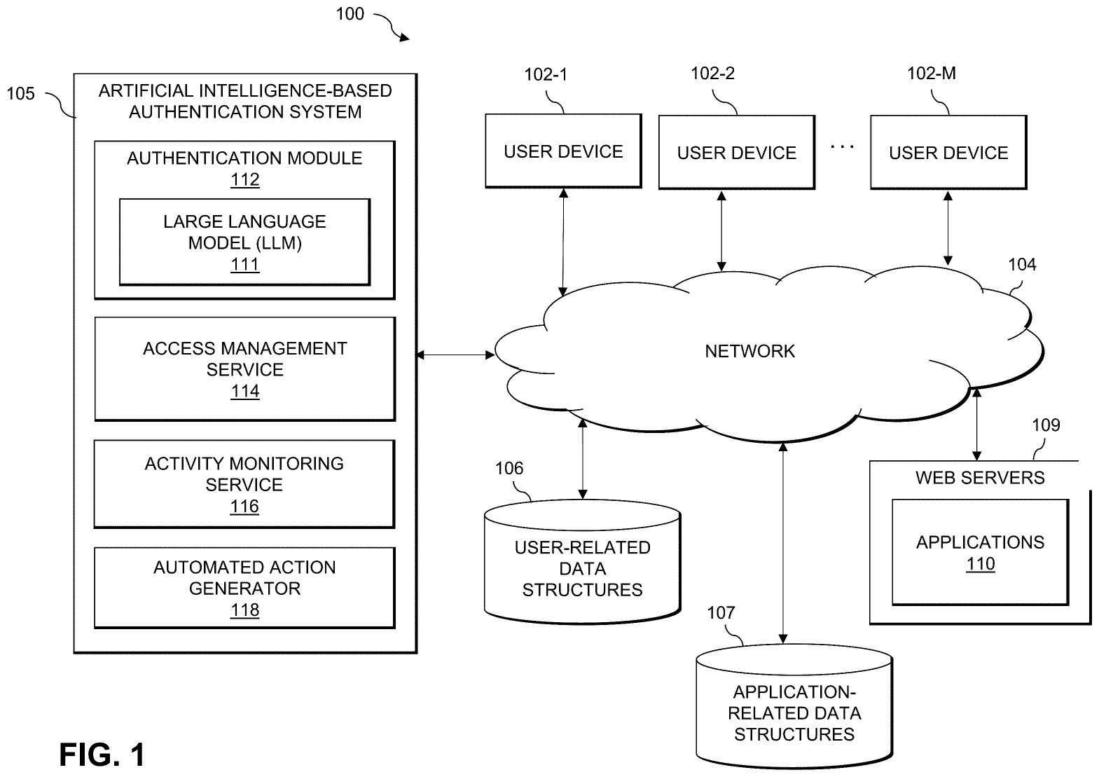

FIG. 1 shows a computer network (also referred to herein as an information processing system) 100 configured in accordance with an illustrative embodiment. The computer network 100 comprises a plurality of user devices 102-1, 102-2, . . . 102-M, collectively referred to herein as user devices 102. The user devices 102 are coupled to a network 104, where the network 104 in this embodiment is assumed to represent a sub-network or other related portion of the larger computer network 100. Accordingly, elements 100 and 104 are both referred to herein as examples of “networks” but the latter is assumed to be a component of the former in the context of the FIG. 1 embodiment. Also coupled to network 104 is artificial intelligence-based authentication system 105 and one or more applications 110 (e.g., one or more enterprise applications, one or more protected resource-related applications, etc.) executing on a set of web servers 109.

The user devices 102 may comprise, for example, mobile telephones, laptop computers, tablet computers, desktop computers or other types of computing devices. Such devices are examples of what are more generally referred to herein as “processing devices.” Some of these processing devices are also generally referred to herein as “computers.”

The user devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Additionally, the artificial intelligence-based authentication system 105 can have associated user-related data structures 106 configured to store one or more user profiles and various types of user-related data (e.g., usage data, temporal data, role/objective data, etc.) pertaining to one or more users. Also, as depicted in FIG. 1, the artificial intelligence-based authentication system 105 can have application-related data structures 107 configured to store one or more application profiles and various types of data pertaining to one or more applications (e.g., usage data, temporal data, etc.). The term “data structure,” as used herein, is intended to be broadly construed, so as to encompass, for example, a wide variety of different types of tables, arrays, graphs, trees, linked lists, and additional or alternative data relation mechanisms, as well as portions or combinations thereof. Accordingly, a given data structure can comprise a combination of multiple smaller data structures, possibly of different types, or a portion of a larger data structure. Numerous other arrangements are possible.

The user-related data structures 106 and/or application-related data structures 107 in the present embodiment are implemented using one or more storage systems associated with the artificial intelligence-based authentication system 105. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with the artificial intelligence-based authentication system 105 are one or more input-output devices, which illustratively comprise keyboards, displays or other types of input-output devices in any combination. Such input-output devices can be used, for example, to support one or more user interfaces to the artificial intelligence-based authentication system 105, as well as to support communication between the artificial intelligence-based authentication system 105 and other related systems and devices not explicitly shown.

Additionally, the artificial intelligence-based authentication system 105 in the FIG. 1 embodiment is assumed to be implemented using at least one processing device. Each such processing device generally comprises at least one processor and an associated memory, and implements one or more functional modules for controlling certain features of the artificial intelligence-based authentication system 105.

More particularly, the artificial intelligence-based authentication system 105 in this embodiment can comprise a processor coupled to a memory and a network interface.

The processor illustratively comprises a microprocessor, a central processing unit (CPU), a graphics processing unit (GPU), a tensor processing unit (TPU), a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows the artificial intelligence-based authentication system 105 to communicate over the network 104 with the user devices 102, and illustratively comprises one or more conventional transceivers.

The artificial intelligence-based authentication system 105 further comprises an authentication module 112, which includes a large language model (LLM) 111, an access management service 114, an activity monitoring service 116, and an automated action generator 118.

As detailed herein, an LLM is merely an example, and one or more other types of machine learning models can be used. Also, LLM 111, although illustratively shown as being within authentication module 112, can in other embodiments be implemented at least in part externally to authentication module 112. For example, authentication module 112 can be configured to access one or more LLMs on a separate platform over a network (e.g., network 104).

It is to be appreciated that this particular arrangement of elements 112, 114, 116 and 118 illustrated in the artificial intelligence-based authentication system 105 of the FIG. 1 embodiment is presented by way of example only, and alternative arrangements can be used in other embodiments. For example, the functionality associated with elements 112, 114, 116 and 118 in other embodiments can be combined into a single module, or separated across a larger number of modules. As another example, multiple distinct processors can be used to implement different ones of elements 112, 114, 116 and 118 or portions thereof.

At least portions of elements 112, 114, 116 and 118 may be implemented at least in part in the form of software that is stored in memory and executed by a processor.

It is to be understood that the particular set of elements shown in FIG. 1 for dynamically managing resource access privileges using artificial intelligence techniques involving user devices 102 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, two or more of artificial intelligence-based authentication system 105, user-related data structures 106, application-related data structures 107, and web servers 109 can be on and/or part of the same processing platform.

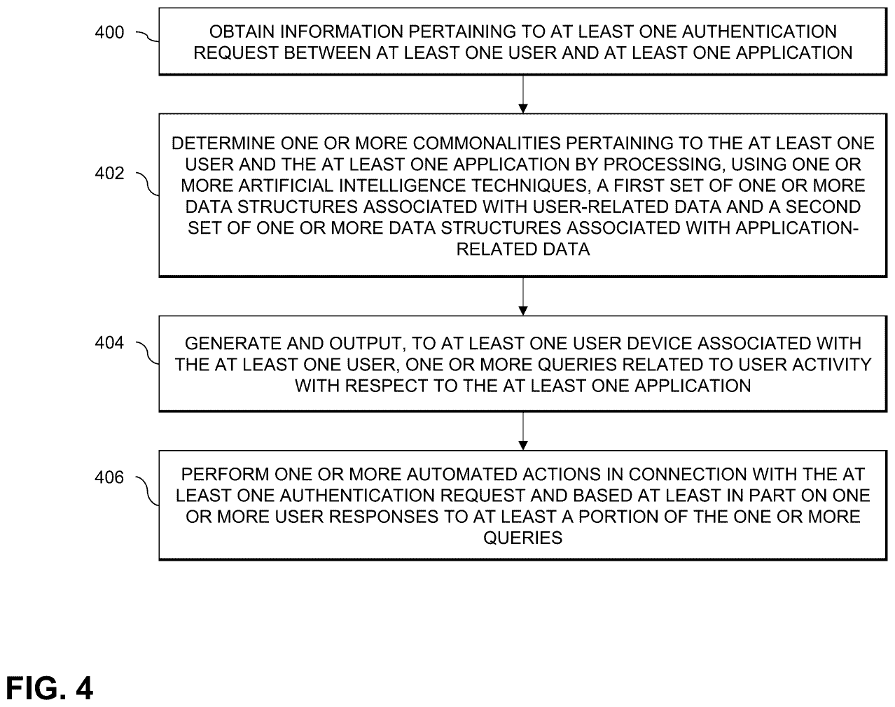

An exemplary process utilizing elements 112, 114, 116 and 118 of an example artificial intelligence-based authentication system 105 in computer network 100 will be described in more detail with reference to the flow diagram of FIG. 4.

Accordingly, at least one embodiment includes dynamically managing resource access privileges using artificial intelligence techniques. As further detailed herein, such an embodiment can include implementing LLM-based authentication techniques (in the form, e.g., of artificial intelligence-based authentication system 105), which precludes the need for a conventional directory-based authentication model.

With respect to user-based implementations and/or implications, one or more embodiments include determining and/or leveraging information about influence and/or interest of a particular user. Such information can include, for example, information related to activities that the user routinely performs (e.g., the types of tasks being performed, temporal information associated with user performance of activities, etc.), information related to privileges that the user consumes and/or exercises, etc. Additionally, such information can be obtained and/or collected in the form of user profiles, which can include natural language-based descriptions (generated and/or provided, for example, by the user and/or at least one related administrator) pertaining to the user, the user's role(s), the user's actions, the user's application skills, etc.

With respect to application-based implementations and/or implications, at least one embodiment includes determining and/or leveraging information about needs and/or usage of a particular application. Such information can include, for example, information related to application usage patterns across users, information related to privileges needed by one or more users to access the application, temporal information associated with one or more application operations, etc. Additionally, such information can be obtained and/or collected in the form of application profiles, which can include natural language-based descriptions of the application, possible actions of the application, user role needs associated with the application, etc. Also, in such an embodiment, the application can have and/or be associated with an intent-based front end application programming interface (API).

In at least one embodiment, a given application can expose one or more web APIs and also provide at least one specific uniform resource locator (URL) which returns API metadata and features exposed by the application. The API metadata and features can be expressed, e.g., in the form of web services description language (WSDL) and/or open API specifications (e.g., for RESTful interfaces). Accordingly, such an embodiment can include leveraging such technology for curating natural language descriptions for one or more applications. Additionally, in an example embodiment, an application description service can be hosted in the environment that prepares the natural language descriptions for applications, and the application description service can take a list of applications and/or scan the environment to identify the applications, and invoke the API metadata and feature URL(s) and extract the API metadata. The application description service can then convert the API metadata into at least one natural language description, for example, by concatenating the name of the function and comma separated list of parameters and passing such information through at least one LLM. The at least one LLM can, for example, compress the provided information into a more distilled format.

Further, one or more embodiments can include coordinating between application-based natural language-based descriptions and user-based natural language-based descriptions across multiple entities (e.g., enterprises and/or teams thereof, co-hosted environments, user premises, etc.) and determining and/or positing at least one user experience that renders abnormal behavior more difficult with decreased inconvenience to the user. In such an embodiment, the coordination includes identifying and/or finding at least one intersection and/or overlap between application features and user needs, as further detailed herein. By finding such an intersection, at least one embodiment includes attempting to determine and/or identify what assets and/or resources (e.g., security permissions) can and/or should be given to the user in question. Additionally, if a specific operation that the user is performing does not match the user profile, then such an operation can be considered abnormal behavior and that the user has potentially been compromised. In such an instance, one or more embodiments can include forcing an interaction and/or dialog with the user to determine the legitimacy of the operation.

More particularly, at least one embodiment includes determining and/or collecting user behavior-related data by processing data associated with one or more functional groups and data associated with related user needs (e.g., users within an enterprise who need to know certain information, users within an enterprise who need to share certain information, required privileges and operations associated with certain users within an enterprise).

In such an embodiment, processing such data can include tracing for and/or detecting one or more instances of abnormal user behaviors. Such tracing can be carried out, for example, through one or more application alerts and/or monitoring data capturing the abnormal behavior(s). Abnormal behavior, as detailed herein, can include an operation that the user is not expected to perform and/or is not present in the user profile. Additionally, the degree of inconvenience to a user, with respect to a given application, can be determined based at least in part on whether user behaviors and application behaviors coincide and the extent to which such behaviors coincide (e.g., as determined in connection with identifying intersection(s) and/or overlap(s) between application profiles and user profiles).

As further detailed herein, one or more embodiments include leveraging at least one LLM to detect intent in user communications, to determine and/or generate answers to user prompts, and to prompt one or more questions to users in connection with one or more user communications. Such an embodiment can include leveraging at least one LLM such as, for example, at least one bidirectional encoder representations from transformers (BERT), at least one generative pretrained transformer (GPT), etc. Also, such an embodiment can include implementing and/or maintaining at least one user profile database and at least one application profile database, which can preclude the need for an active directory. In such an embodiment, user profiles can include natural language descriptions of the type(s) of jobs that certain users perform. For example, such a description might include the following: “User-A is database administrator who is proficient in MySQL. User-A reads tasks from a software development application, which requires database administration tasks such as reconfiguring structured query language (SQL) pools, etc. User-A typically takes 10-15 minutes for a task, but some tasks may go on for five hours if they require information technology (IT) approvals.”

Additionally, user profiles can also contain detailed information about the primary role(s) of the corresponding users, and information pertaining to applications in which the corresponding users are skilled in and/or applications which the corresponding users will be using, with specific roles related to such applications identified in natural language descriptions. Further, user profiles can include information pertaining to the specific and/or unique operations performed by the corresponding users on the given applications.

In at least one embodiment, such operations can be mapped to one or more intent-based APIs exposed from the applications. As used herein, an intent-based API refers to an API that is designed to model user intent. More particularly, an intent-based API can contain a primary verb indicating what action is being performed, a primary noun identifying the resource on which this action is being performed, and one or more parameters in the form of natural language adjectives with values. By way merely of example, at least one embodiment can include modeling a Create Disk API with the following aspects: Verb=Create, Noun=Disk, Adjectives=(Size=30 MB, type=RAID_10). Further, in at least one embodiment, user profiles can include information pertaining to typical amounts of time taken for such operations, including any exception conditions, wherein the exception conditions can also be mapped to or more intent-based APIs exposed from the applications.

In one or more embodiments, application profiles can include natural language descriptions of the type(s) of operations that the corresponding applications expose. For example, such a description might include the following: “Software development application-B is a software tool for project managers who are publishing software and other artifacts. Administrators can allow access to project managers, and project managers can perform operations such as creating and managing projects and creating software releases. Operators can view the projects and software releases, and they can also post software updates.” Such a description can be built, for example, using one or more intent-based APIs exposed by the corresponding applications.

Additionally, application profiles can also contain detailed information about the primary purpose of the corresponding applications (e.g., genres such as DevOps, source administrator tools, software publishing, etc.), the roles and role hierarchies of the corresponding applications, the entities managed by the corresponding applications (e.g., projects, software releases, updates, etc.) and operations (e.g., perform, view, allows, post, etc.) performed by the corresponding applications. Also, at least a portion of such detailed information can be mapped to one or more intent-based APIs exposed by the corresponding applications. Further, application profiles can include information pertaining to typical amounts of time taken for operations performed by the corresponding applications, including any exception conditions, wherein the exception conditions can also be mapped to or more intent-based APIs exposed from the applications.

At least one embodiment also includes monitoring user circle behavior. As used herein, a user circle refers to a common set of operations performed by the user group(s) to which the user belongs (such as, e.g., groups within an enterprise or other organization to which the user has been assigned). By way of illustration, in an example scenario, operators may have read only access to certain configuration data, while administrators have full access to the configuration data. User circles can be utilized to help understand possible and/or permissible operations within a given group, even if such operations are not currently performed by a particular user in question. If any operation performed by anyone within a given user circle is considered abnormal and then resolved to be legitimate, that operation can be allowed for all users in the group.

Additionally, at least one embodiment can include implementing and/or monitoring activity with respect to at least one group sign-on page for one or more designated user groups. Additionally, a user circle of influence can be determined, for example, by what operations are performed by individual users and by groups of users, as well as by temporal patterns with respect to operation performance.

As also detailed herein, at least one embodiment includes implementing LLM-based authentication services (LLM-Auth-Services). In such an embodiment, when a user is accessing a tool, the tool securely connects to LLM-Auth-Services by providing a reference to the user profile(s) and the application profile(s) in question. The LLM-Auth-Services then computes an intersection of interests by determining and/or identifying at least one intersection between the user profile(s) and application profile(s). Such a computation involves identifying the common portions from the user and the application profiles. By way of example, consider a scenario wherein the user is accessing a software development application such as an Agile tool, then an intersection might include the following:

“User: The user reads tasks from the Agile tool and posts software updates. The user typically takes 10-15 minutes for a software update, but some may go on for approximately five hours if an update requires IT approvals.

Agile Tool: Operators of the application can view the projects and software releases, and can post software updates.”

In accordance with such an example, “reads tasks” and “post software updates” can be mapped to one or more intent-based APIs for the Agile tool. Also, on the application side, operators (e.g., users) can have corresponding intent-based APIs for “view projects,” “view software release,” and “post software updates.” Such action descriptions can point to potential roles as well as fine-grained privileges needed for these APIs to perform. Additionally, one or more embodiments can include associating one or more service level agreements (SLAs) for the typical tasks completed in 10-15 minutes for a task and associating one or more separate SLAs for the longer-duration tasks which require IT approvals.

By way of further illustration, consider an example scenario wherein a user is logging in to an application for the first time. In such a scenario, one or more embodiments can include, via LLM-Auth-Services, creating a set of questions from available data (e.g., data derived from the natural language descriptions of user profiles and/or application profiles). Such questions can be of multiple types, such as, for example, questions eliciting an affirmative response (e.g., “Will you be reading tasks from the Agile Tool?”), questions eliciting a negative response (e.g., “Will you be creating projects?”), questions contradicting a role (e.g., “You will need project creation privileges; do you already have such privileges?”), and questions confirming a role (e.g., “You will need posting software update privileges, correct?”). Also, in such an embodiment, because an LLM is framing the questions from knowledge present in the user profile(s) and/or application profile(s), the LLM should already know what sort of answers are expected.

Further, continuing with the above example scenario, the user is navigated through the set of questions to determine the user's knowledge and/or the intended scope of operations with respect to the application. Answers to the questions are processed and/or checked by the LLM-Auth-Services. Some questions (e.g., questions pertaining to the duration of the operation) may not necessarily be predetermined and can depend on the user's experience. In such a scenario, instead of exact values such as, for example, 10-15 minutes, terms such as “under an hour” or “a few hours” can be used.

In the case of affirmative answers, the user is granted an amount of privileges that is based at least in part on the intersection of interests across the user and application profiles. In a situation wherein there are not sufficient affirmative answers, data associated with one or more other users having the same intersection of interests can be utilized, and upon their approval, the initial user is allowed access to the application.

While the above describes an initial grant process with respect to application access, one or more embodiments include implementing one or more subsequent grants of application access to the user. In connection with such subsequent grants, one or more embodiments include caching information pertaining to the state of the user for a time (e.g., a given time to live (TTL)) and refreshing such information based on subsequent accesses. Additional context can be built, for example, based on the user's usage pattern(s) (e.g., APIs used, entities accessed, time taken, etc.), and such context can be used to augment the user's profile.

Further, as the user performs one or more actions in the application, additional descriptions can be added to the user profile and/or to the corresponding database, which capture one or more specific usage patterns. For example, a specific project manager may create projects but not other tasks, one operator may be posting small-sized update packages while another operator may be posting larger-sized update packages (and hence their SLAs (e.g., time for action) may be different), etc. Application descriptions can also be updated based on the operations of the collective users that are using the application (e.g., because users typically use small portions of applications, leaving large portions untouched). In such an embodiment, if a first user is accessing a given part of the application that is unused by multiple other users, it can be determined that the first user is exhibiting abnormal and/or improper behavior. Also, in one or more embodiments, LLM-based-Auth-Services can be utilized to continuously monitor usage patterns and add additional description sections to user and application profiles with detailed and/or specific information (e.g., specific APIs, precise time durations, etc.).

Also, when an operation is performed in the application by the user (e.g., the first time deletion of a project), a graded validation of user intent can be provided. For example, when the operation is performed for the first time by any user in the application, one or more embodiments include generating and outputting questions, to the user, related to privileges and/or effects of that operation. Additionally, such an embodiment can include seeking approval from a supervisor and/or a similar interested user for that application instance. By way of further example, when the operation is performed for the first time by a particular user in the application, such an embodiment includes generating and outputting questions, to the particular user, related to privileges and/or effects of that operation, as well as checking for similarity of the operation with respect to previous application instances (e.g., force delete option used, etc.). If a new pattern is found and/or identified, the particular user can be asked one or more questions contradicting a role and/or one or more questions confirming a role.

When the operation is performed subsequent times, at least one embodiment includes checking for similarity of the operation with respect to previous application instances (e.g., force delete option used, etc.), and positing one or more questions (e.g., one or more questions contradicting a role and/or one or more questions confirming a role) at random times, increasing frequency for non-similar operations. Further, in one or more embodiments, durations exceeding a designated amount in a given activity can be used in connection with terminating operations such as, e.g., logging out, deleting licenses, etc. Such resources can be re-acquired by the user at the next login.

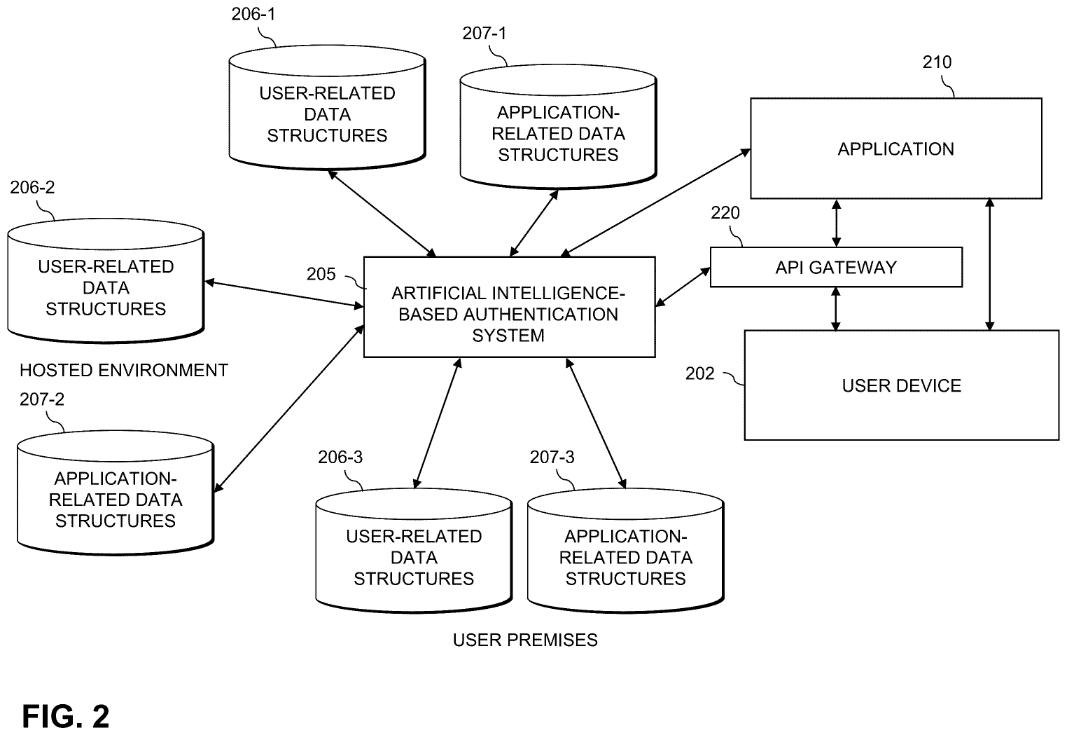

FIG. 2 shows example system architecture in an illustrative embodiment. By way of illustration, FIG. 2 depicts a user device 202 connecting to an application 210 (e.g., an application home page). The application 210 redirects the user device 202 to artificial intelligence-based authentication system 205 (which can include, e.g., LLM-based-Auth-Services). The artificial intelligence-based authentication system 205 then interacts with user-related data structures 206-1 and application-related data structures 207-1 to identify and/or obtain profiles pertaining to the logged-in user and the application 210, and performs and/or determines an intersection of the user and application profiles. Based at least in part on such cross-profile analysis, the artificial intelligence-based authentication system 205 creates at least one set of questions to be prompted to the user via user device 202 and API gateway 220. The user is then navigated through at least a portion of the questions, and based at least in part on the user's responses (e.g., approval can be required and/or acquired for sufficiently unsatisfactory responses), the user can be granted access to at least a portion of application 210.

Additionally, as also depicted in FIG. 2, API gateway 220 can be used by artificial intelligence-based authentication system 205 to monitor subsequent operations by the user (via user device 202) in the application 210, and the user profile and/or the application profile descriptions can be augmented in user-related data structures 206-1 and/or application-related data structures 207-1 based at least in part on one or more determined usage patterns.

Further, as additionally depicted in FIG. 2, at least one embodiment can include implementing different types of deployment such as, for example, a hosted environment and user premises. In such an embodiment, a hosted environment deployment can have respective user-related data structures 206-2 and application-related data structures 207-2, and a user premises deployment can have respective user-related data structures 206-3 and application-related data structures 207-3. Accordingly, in such an embodiment, artificial intelligence-based authentication system 205 can be provided with access to each of these databases, whereby artificial intelligence-based authentication system 205 can determine at least one intersection across at least a portion of two or more profiles contained therein. This can ensure, for example, that certain types of behaviors enforced across deployments are taken into account for determining patterns and/or instances of abnormal user behavior.

As detailed herein, one or more embodiments include implementing various modules and/or elements such as, e.g., a user registration and profile management module, an authentication module, an access management service, an activity monitoring service, an automated action generator and a circle of influence determiner. The user registration and profile management module can handle and/or process user registration (with the artificial intelligence-based authentication system) and profile updates, as well as facilitate parsing of natural language descriptions during registration, and communicate with a user profile and application profile database to store and/or retrieve user profiles. The authentication module can manage user authentication and/or authorization in connection with one or more applications, process user responses to system-generated queries to learn and/or understand user roles and/or tasks during authentication, and work with the access management service to determine and/or grant appropriate access rights to users.

Additionally, the access management service can determine and/or manage user access privileges with respect to one or more applications, work with the authentication module to adjust access rights based, e.g., on task relevance and user role(s), and dynamically adjust access privileges based at least in part on real-time activity data processed by the activity monitoring service. Further, the activity monitoring service can monitor user behavior in connection with one or more applications in real-time, analyze behavioral patterns and trigger adjustments in a user's circle of influence, and work with the access management service to adjust access privileges.

Also, the automated action generator can integrate with one or more external tools for various task executions, and can update user profiles and/or application profiles based at least in part on task interactions. Further, the circle of influence determiner can analyze patterns of operation hours to determine one or more user circles, adjust a circle of interest based at least in part on one or more observed patterns, and work with the access management service to dynamically adjust access privileges.

Accordingly, as detailed herein, one or more embodiments include generating and/or implementing LLM-based-Auth-Services, which eliminate the need for managing users as groups based on usage patterns. Additionally, in such an embodiment, the LLM-based-Auth-Services can provide fine-grained access privileges that can be dynamically constructed without the need to create additional roles with specific privileges.

Further, in at least one embodiment, natural language descriptions, along with intent-based APIs, are used to derive access and operation privileges. Also, in such an embodiment, users are authenticated through knowledge derived from profiles (e.g., user profiles and application profiles), wherein such knowledge can be derived from questions and/or answers which can also be created dynamically without the need for pre-populated questions. Additionally, the generation of such questions can be carried out in connection with varying levels of difficulty based at least in part on whether the user is making an initial attempt at application privileges access versus a subsequent attempt.

Also, in one or more embodiments, application access privileges can be dynamically revoked from users in an adaptive manner based at least in part on changes to corresponding user profiles and/or related security alerts, ensuring prompt and/or immediate responses to potential security threats. Further, as detailed herein, at least one embodiment includes authenticating users based at least in part on the specific tasks that the users perform with respect to a given application, which provides a more granular and context-aware approach than conventional techniques. For example, such an embodiment can include framing authentication-related questions based on knowledge related to a particular application, collected from application profiles and/or user profiles, reducing chances of users unknown to the application gaining access to the application.

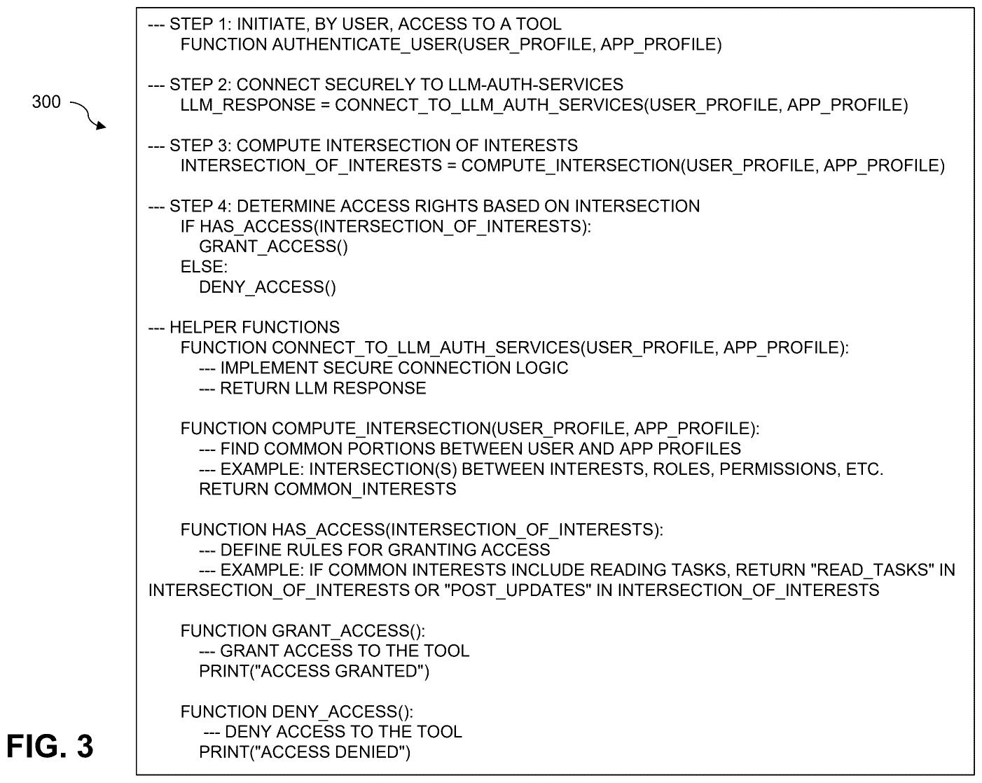

FIG. 3 shows example pseudocode for implementing at least a portion of an artificial intelligence-based authentication system in an illustrative embodiment. In this embodiment, example pseudocode 300 is executed by or under the control of at least one processing system and/or device. For example, the example pseudocode 300 may be viewed as comprising a portion of a software implementation of at least part of artificial intelligence-based authentication system 105 of the FIG. 1 embodiment.

The example pseudocode 300 illustrates a user initiating access to a tool (e.g., a particular application or resource therein), wherein the user wants to access the specific tool. As illustrated in example pseudocode 300, one or more embodiments include authenticating the user using the LLM-Auth-Services. Also, example pseudocode 300 depicts connecting securely to the LLM-Auth-Services, wherein a secure connection to the LLM-Auth-Services can be established using the user profile and the application profile as references. Further, example pseudocode 300 illustrates computing at least one intersection of interests by determining one or more common portions between the user and application profiles. For example, at least one embodiment includes identifying shared interests, roles, permissions, etc. across the user profile and the application profile. Additionally, as depicted, example pseudocode 300 illustrates determining access rights attributable to the user based at least in part on the intersection computation. For example, if the intersection computation identifies one or more relevant interests (e.g., reading tasks, posting updates, etc.) as common between the user and application profiles, access to the application is granted to the user. Otherwise, application access to the user is denied.

It is to be appreciated that this particular example pseudocode shows just one example implementation of an artificial intelligence-based authentication system with automated processing of data structures, and alternative implementations can be used in other embodiments.

It is to be appreciated that some embodiments described herein utilize one or more artificial intelligence models. It is to be appreciated that the term “model,” as used herein, is intended to be broadly construed and may comprise, for example, a set of executable instructions for generating computer-implemented recommendations and/or predictions. For example, one or more of the models described herein may be trained to generate recommendations and/or predictions pertaining to user authentication and/or user access with respect to one or more applications and/or resources related thereto based on user profile data, application profile data, user response data, etc., and such recommendations and/or predictions can be used to initiate one or more automated actions (e.g., automatically adjusting user access to one or more portions of one or more applications and/or resources related thereto, automatically training and/or fine-tuning the one or more models used to generate the recommendations and/or predictions, etc.).

FIG. 4 is a flow diagram of a process for dynamically managing resource access privileges using artificial intelligence techniques in an illustrative embodiment. It is to be understood that this particular process is only an example, and additional or alternative processes can be carried out in other embodiments.

In this embodiment, the process includes steps 400 through 406. These steps are assumed to be performed by the artificial intelligence-based authentication system 105 utilizing elements 112, 114, 116 and 118.

Step 400 includes obtaining information pertaining to at least one authentication request between at least one user and at least one application. In at least one embodiment, obtaining information pertaining to at least one authentication request between at least one user and at least one application includes receiving indication of the at least one authentication request from the at least one application in conjunction with identifying information associated with the at least one user.

Step 402 includes determining one or more commonalities pertaining to the at least one user and the at least one application by processing, using one or more artificial intelligence techniques, a first set of one or more data structures associated with user-related data and a second set of one or more data structures associated with application-related data. In one or more embodiments, processing the first set of one or more data structures associated with user-related data and the second set of one or more data structures associated with application-related data includes using one or more LLMs.

The first set of one or more data structures associated with user-related data can include natural language descriptions related to one or more of activities performed by the at least one user, temporal information associated with user performance of one or more activities, access privileges utilized by the at least one user, one or more roles associated with the at least one user, and one or more skills associated with the at least one user. Additionally, the second set of one or more data structures associated with application-related data can include natural language descriptions related to one or more of one or more purposes of the at least one application, application usage patterns across multiple users, privileges needed by one or more users to access the at least one application, temporal information associated with one or more application operations, one or more user role requirements associated with the at least one application, and one or more user skill requirements associated with the at least one application.

Step 404 includes generating and outputting, to at least one user device associated with the at least one user, one or more queries related to user activity with respect to the at least one application. In at least one embodiment, generating the one or more queries related to user activity with respect to the at least one application includes using the one or more LLMs to generate the one or more queries.

Step 406 includes performing one or more automated actions in connection with the at least one authentication request and based at least in part on one or more user responses to at least a portion of the one or more queries. In one or more embodiments, performing one or more automated actions includes automatically granting at least a portion of the at least one authentication request between at least one user and at least one application based at least in part on the one or more user responses to the at least a portion of the one or more queries. In such an embodiment, performing one or more automated actions can include automatically processing, using at least one API, activity data attributed to the at least one user in connection with the at least one application subsequent to the granting of the at least a portion of the at least one authentication request.

Further, in such an embodiment, performing one or more automated actions can include automatically modifying one or more of at least a portion of the first set of one or more data structures associated with user-related data and at least a portion of the second set of one or more data structures associated with application-related data based at least in part on the processing of the activity data. Also, in such an embodiment, performing one or more automated actions can include one or more of automatically granting one or more additional application access privileges to the at least one user and automatically revoking one or more application access privileges from the at least one user based at least in part on the processing of the activity data.

Additionally or alternatively, performing one or more automated actions can include automatically training at least a portion of the one or more artificial intelligence techniques based at least in part on the one or more user responses to the at least a portion of the one or more queries.

Accordingly, the particular processing operations and other functionality described in conjunction with the flow diagram of FIG. 4 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to dynamically manage resource access privileges by processing user-related and application-related data structures using artificial intelligence techniques. These and other embodiments can effectively overcome problems associated with security risks related to over-provisioning of resource access.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the system 100. For example, containers can be used to implement respective processing devices providing compute and/or storage services of a cloud-based system. Again, containers may be used in combination with other virtualization infrastructure such as virtual machines implemented using a hypervisor.

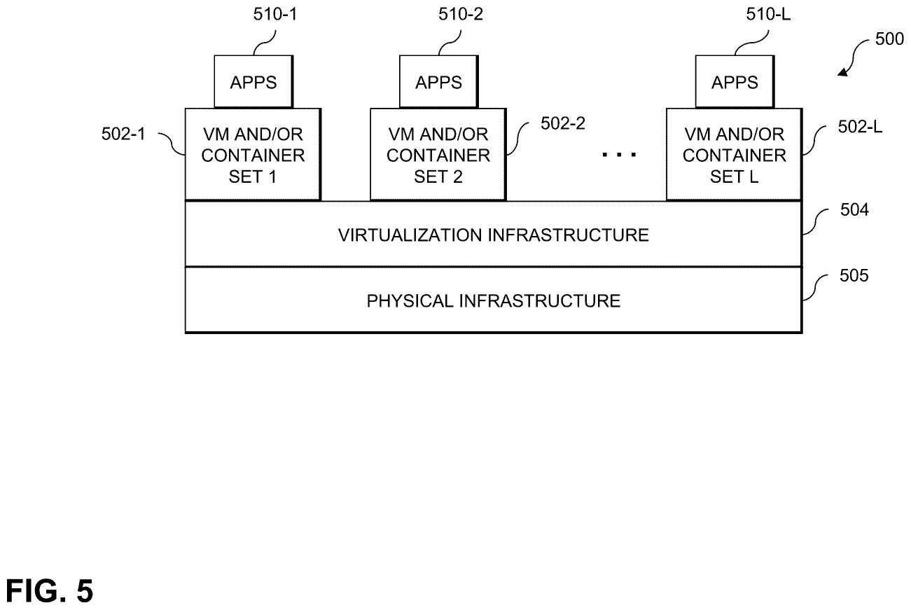

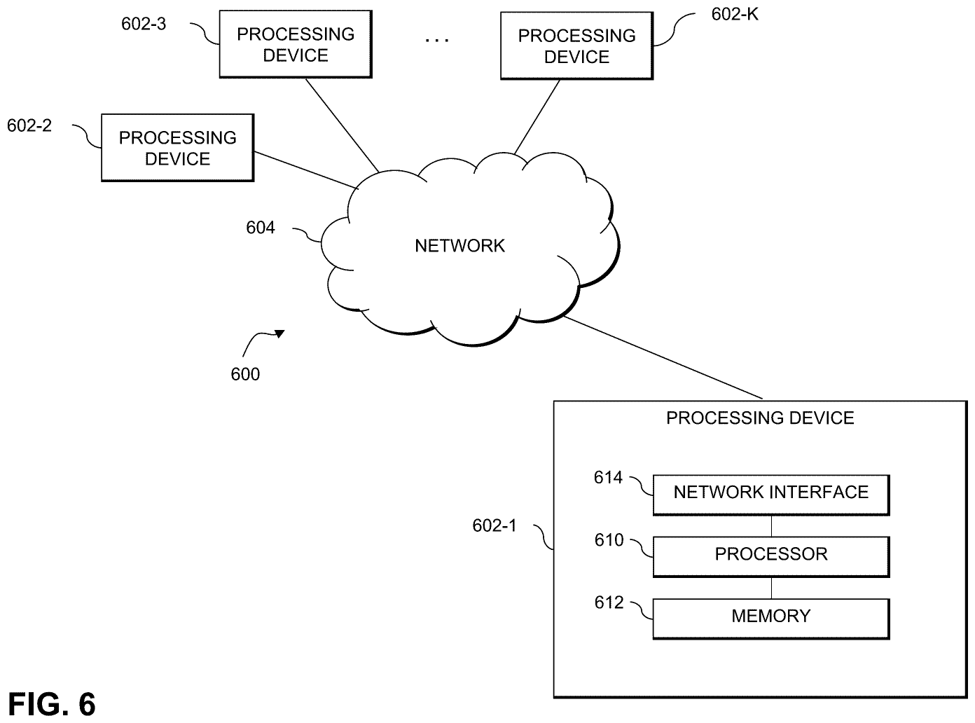

Illustrative embodiments of processing platforms will now be described in greater detail with reference to FIGS. 5 and 6. Although described in the context of system 100, these platforms may also be used to implement at least portions of other information processing systems in other embodiments.

FIG. 5 shows an example processing platform comprising cloud infrastructure 500. The cloud infrastructure 500 comprises a combination of physical and virtual processing resources that are utilized to implement at least a portion of the information processing system 100. The cloud infrastructure 500 comprises multiple virtual machines (VMs) and/or container sets 502-1, 502-2, . . . 502-L implemented using virtualization infrastructure 504. The virtualization infrastructure 504 runs on physical infrastructure 505, and illustratively comprises one or more hypervisors and/or operating system level virtualization infrastructure. The operating system level virtualization infrastructure illustratively comprises kernel control groups of a Linux operating system or other type of operating system.

The cloud infrastructure 500 further comprises sets of applications 510-1, 510-2, . . . 510-L running on respective ones of the VMs/container sets 502-1, 502-2, . . . 502-L under the control of the virtualization infrastructure 504. The VMs/container sets 502 comprise respective VMs, respective sets of one or more containers, or respective sets of one or more containers running in VMs. In some implementations of the FIG. 5 embodiment, the VMs/container sets 502 comprise respective VMs implemented using virtualization infrastructure 504 that comprises at least one hypervisor.

A hypervisor platform may be used to implement a hypervisor within the virtualization infrastructure 504, wherein the hypervisor platform has an associated virtual infrastructure management system. The underlying physical machines comprise one or more information processing platforms that include one or more storage systems.

In other implementations of the FIG. 5 embodiment, the VMs/container sets 502 comprise respective containers implemented using virtualization infrastructure 504 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element is viewed as an example of what is more generally referred to herein as a “processing device.” The cloud infrastructure 500 shown in FIG. 5 may represent at least a portion of one processing platform. Another example of such a processing platform is processing platform 600 shown in FIG. 6.

The processing platform 600 in this embodiment comprises a portion of system 100 and includes a plurality of processing devices, denoted 602-1, 602-2, 602-3, . . . 602-K, which communicate with one another over a network 604.

The network 604 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 602-1 in the processing platform 600 comprises a processor 610 coupled to a memory 612.

The processor 610 comprises a microprocessor, a CPU, a GPU, a TPU, a microcontroller, an ASIC, a FPGA or other type of processing circuitry, as well as portions or combinations of such circuitry elements.

The memory 612 comprises RAM, ROM or other types of memory, in any combination. The memory 612 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 602-1 is network interface circuitry 614, which is used to interface the processing device with the network 604 and other system components, and may comprise conventional transceivers.

The other processing devices 602 of the processing platform 600 are assumed to be configured in a manner similar to that shown for processing device 602-1 in the figure.

Again, the particular processing platform 600 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of an information processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A computer-implemented method comprising:
obtaining information pertaining to at least one authentication request between at least one user and at least one application;
determining one or more commonalities pertaining to the at least one user and the at least one application by processing, using one or more artificial intelligence techniques, a first set of one or more data structures associated with user-related data and a second set of one or more data structures associated with application-related data;
generating and outputting, to at least one user device associated with the at least one user, one or more queries related to user activity with respect to the at least one application; and
performing one or more automated actions in connection with the at least one authentication request and based at least in part on one or more user responses to at least a portion of the one or more queries;
wherein the method is performed by at least one processing device comprising a processor coupled to a memory.

2. The computer-implemented method of claim 1, wherein processing the first set of one or more data structures associated with user-related data and the second set of one or more data structures associated with application-related data comprises using one or more large language models (LLMs).

3. The computer-implemented method of claim 2, wherein generating the one or more queries related to user activity with respect to the at least one application comprises using the one or more LLMs to generate the one or more queries.

4. The computer-implemented method of claim 1, wherein performing one or more automated actions comprises automatically granting at least a portion of the at least one authentication request between at least one user and at least one application based at least in part on the one or more user responses to the at least a portion of the one or more queries.

5. The computer-implemented method of claim 4, wherein performing one or more automated actions comprises automatically processing, using at least one application programming interface (API), activity data attributed to the at least one user in connection with the at least one application subsequent to the granting of the at least a portion of the at least one authentication request.

6. The computer-implemented method of claim 5, wherein performing one or more automated actions comprises automatically modifying one or more of at least a portion of the first set of one or more data structures associated with user-related data and at least a portion of the second set of one or more data structures associated with application-related data based at least in part on the processing of the activity data.

7. The computer-implemented method of claim 5, wherein performing one or more automated actions comprises one or more of automatically granting one or more additional application access privileges to the at least one user and automatically revoking one or more application access privileges from the at least one user based at least in part on the processing of the activity data.

8. The computer-implemented method of claim 1, wherein performing one or more automated actions comprises automatically training at least a portion of the one or more artificial intelligence techniques based at least in part on the one or more user responses to the at least a portion of the one or more queries.

9. The computer-implemented method of claim 1, wherein the first set of one or more data structures associated with user-related data comprises natural language descriptions related to one or more of activities performed by the at least one user, temporal information associated with user performance of one or more activities, access privileges utilized by the at least one user, one or more roles associated with the at least one user, and one or more skills associated with the at least one user.

10. The computer-implemented method of claim 1, wherein the second set of one or more data structures associated with application-related data comprises natural language descriptions related to one or more of one or more purposes of the at least one application, application usage patterns across multiple users, privileges needed by one or more users to access the at least one application, temporal information associated with one or more application operations, one or more user role requirements associated with the at least one application, and one or more user skill requirements associated with the at least one application.

11. The computer-implemented method of claim 1, wherein obtaining information pertaining to at least one authentication request between at least one user and at least one application comprises receiving indication of the at least one authentication request from the at least one application in conjunction with identifying information associated with the at least one user.

12. A non-transitory processor-readable storage medium having stored therein program code of one or more software programs, wherein the program code when executed by at least one processing device causes the at least one processing device:
to obtain information pertaining to at least one authentication request between at least one user and at least one application;
to determine one or more commonalities pertaining to the at least one user and the at least one application by processing, using one or more artificial intelligence techniques, a first set of one or more data structures associated with user-related data and a second set of one or more data structures associated with application-related data;
to generate and output, to at least one user device associated with the at least one user, one or more queries related to user activity with respect to the at least one application; and
to perform one or more automated actions in connection with the at least one authentication request and based at least in part on one or more user responses to at least a portion of the one or more queries.

13. The non-transitory processor-readable storage medium of claim 12, wherein processing the first set of one or more data structures associated with user-related data and the second set of one or more data structures associated with application-related data comprises using one or more LLMs.

14. The non-transitory processor-readable storage medium of claim 12, wherein performing one or more automated actions comprises automatically granting at least a portion of the at least one authentication request between at least one user and at least one application based at least in part on the one or more user responses to the at least a portion of the one or more queries.

15. The non-transitory processor-readable storage medium of claim 14, wherein performing one or more automated actions comprises automatically processing, using at least one API, activity data attributed to the at least one user in connection with the at least one application subsequent to the granting of the at least a portion of the at least one authentication request.

16. The non-transitory processor-readable storage medium of claim 12, wherein performing one or more automated actions comprises automatically training at least a portion of the one or more artificial intelligence techniques based at least in part on the one or more user responses to the at least a portion of the one or more queries.

17. An apparatus comprising:
at least one processing device comprising a processor coupled to a memory;
the at least one processing device being configured:
to obtain information pertaining to at least one authentication request between at least one user and at least one application;
to determine one or more commonalities pertaining to the at least one user and the at least one application by processing, using one or more artificial intelligence techniques, a first set of one or more data structures associated with user-related data and a second set of one or more data structures associated with application-related data;
to generate and output, to at least one user device associated with the at least one user, one or more queries related to user activity with respect to the at least one application; and
to perform one or more automated actions in connection with the at least one authentication request and based at least in part on one or more user responses to at least a portion of the one or more queries.

18. The apparatus of claim 17, wherein processing the first set of one or more data structures associated with user-related data and the second set of one or more data structures associated with application-related data comprises using one or more LLMs.

19. The apparatus of claim 17, wherein performing one or more automated actions comprises automatically granting at least a portion of the at least one authentication request between at least one user and at least one application based at least in part on the one or more user responses to the at least a portion of the one or more queries.

20. The apparatus of claim 19, wherein performing one or more automated actions comprises automatically processing, using at least one API, activity data attributed to the at least one user in connection with the at least one application subsequent to the granting of the at least a portion of the at least one authentication request.
